(19) United States
(12) Patent Application Publication
(10) Pub. No.: US 2016/0344036 A1
(43) Pub. Date: Nov. 24, 2016

(54) POLYOLEFINIC PLATE WRAPS, IMPROVED WRAPPED PLATES, IMPROVED LEAD ACID BATTERIES, AND RELATED METHODS

(71) Applicant: Daramic, LLC, Charlotte, NC (US)

(72) Inventors: J. Kevin Whear, Utica, KY (US); Jeffrey K. Chambers, Philpot, KY (US); Robert W. Saffel, Rockport, IN (US); Eric H. Miller, Philpot, KY (US)

(21) Appl. No.: 15/159,925

(22) Filed: May 20, 2016

Related U.S. Application Data
(60) Provisional application No. 62/164,689, filed on May 21, 2015.

(51) Int. Cl. H01M 4/62; H01M 2/16; H01M 2/18; H01M 10/12; H01M 4/14

(52) U.S. Cl. CPC H01M 4/628; H01M 10/12; H01M 4/14; H01M 2/18; H01M 2/1653

(57) ABSTRACT

Disclosed herein are novel or improved porous polyolefinic plate wrap materials for batteries, improved wrapped plates, improved systems, improved batteries or cells, non-PVC plate wraps, non-PVC wrapped plates, non-PVC batteries, and/or methods of production and/or use thereof. The use of such polyolefinic wraps may simplify the construction of batteries, produce more efficient or robust batteries, and/or the like.

### REFERENCE TO RELATED APPLICATION

This application claims the benefit of and priority to U.S. provisional patent application Ser. No. 62/164,689, filed May 21, 2015, which is fully incorporated by reference herein.

### FIELD OF THE INVENTION

In accordance with at least selected embodiments, the present disclosure or invention relates to improved plate wraps for lead acid batteries, flat plate batteries, improved wrapped plates, improved systems, improved batteries, non-PVC plate wraps, non-PVC wrapped plates, non-PVC batteries, and/or methods of production and/or use thereof. In accordance with at least certain embodiments, novel or improved polyolefinic plate wraps, wrapped plates, and lead acid batteries, such as industrial batteries are provided. The novel or improved polyolefinic plate wraps of the present invention may provide batteries or cells with improved performance, reduced lead content, or both.

### BACKGROUND

Lead acid batteries contain a plurality of electrochemical cells. Each cell contains a positive and negative electrode and an electrolyte that allows ionic current between them. Many batteries contain an absorbent glassmat which holds the electrolyte. The electrodes are in the form of a grid plate having a paste of sulfuric acid and lead oxide. In order to prevent the electrodes from contacting each other, the cells further contain a separator. Typically the separator is a microporous polyethylene material. Because the paste coating the electrodes is relatively fragile, the electrodes are wrapped with a protective sheath which retains the paste. Such protective sheaths are often designated plate wraps. The current industry standard for such sheaths is a polyvinyl chloride (PVC) wrap, which is sold under the name KOROSEAL®. Because polyvinyl chloride is impermeable to the electrolyte, the wrap must contain large perforations so that the electrolyte may pass from one electrode to the other. After an electrode is wrapped with the perforated PVC, it must be further affixed to a PVC boot at the bottom of the grid. The boot captures and retains the paste that breaks free of the electrode. Batteries containing an electrode, glassmat, PVC plate wrap, PVC boot and separator are designated “5-point systems.” See FIGS. 5 and 6.

Despite the industry acceptance of the PVC plate wrap, it still suffers from several shortcomings. The perforations (or openings) may be up to one quarter inch in diameter, and as such do not effectively retain all of the paste which breaks free from the electrode. Because the PVC wrap requires a PVC boot, additional manufacturing steps and components are required to prepare a 5-point system. The boot also increases the overall size of the battery, taking up space which might otherwise be filled with active material.

Hence, there is a need for plate wrap that is improved compared with the existing perforated PVC products, for a lead acid battery having fewer components than the traditional 5-point system, and the like.

### SUMMARY

In accordance with at least certain embodiments, it is an object of the invention to provide a plate wrap that is improved compared with the existing perforated PVC products, and/or it is a further object of the invention to provide a lead acid battery having fewer components than the traditional 5-point system.

In accordance with at least selected embodiments, the present disclosure or invention may address the above needs or issues, and/or may provide improved plate wraps for lead acid batteries, improved wrapped plates, improved systems, improved batteries or cells, non-PVC plate wraps, non-PVC wrapped plates, non-PVC batteries, and/or methods of production and/or use thereof. In accordance with at least certain embodiments, aspects or objects, novel or improved polyolefinic plate wraps, wrapped plates, and lead acid batteries, such as industrial batteries are provided. The novel or improved polyolefinic plate wraps of the present invention may provide batteries or cells with improved performance, reduced lead content, or both.

Disclosed herein are novel or improved plate wraps made of porous, preferably microporous, polyolefin, preferably polyethylene. The preferred plate wraps do not contain a PVC polymer. The polyolefinic plate wraps may serve as a drop-in replacement for currently existing PVC plate wraps used in the manufacture of 5-point battery systems (see FIGS. 5 and 6). Because the porous polyolefinic plate wrap is permeable to the electrolyte, it can also serve to augment the function of the traditional battery separator. In some instances, the polyolefinic plate wrap can replace the separator altogether, thereby permitting either the introduction of additional active material into the battery and/or reduction in the size of the battery. Unlike conventional PVC plate wraps, the inventive polyolefinic plate wraps may not require a separate or additional sleeve of separator to retain the active material. Also, in at least particular embodiments, the inventive polyolefinic plate wraps may be sealed along the bottom to form a microporous pocket to retain active material, to enclose the plate, or the like. A wrapped or sealed plate or electrode can then be affixed to a traditional PVC boot, to a novel or improved non-PVC boot, or to the mud rest or battery case if desired (for example, for certain high vibration environs). Also, the conventional PVC wrap and PVC boot may be eliminated altogether to provide a PVC-free battery, industrial battery, traction battery, fork lift battery, fork truck battery, motive power battery, railroad battery, or the like. Removing the PVC boot may permit the introduction of additional active material into the battery and/or reduction in the size of the battery. Also, certain additives or agents may be added to the inventive polyolefinic plate wraps.

### BRIEF DESCRIPTION OF THE DRAWINGS

FIG. 1 depicts a 4-point system in which the boot is eliminated and the PVC plate wrap has been replaced by the inventive polyolefinic plate wrap. The depicted 4-point system may easily be converted to a 5-point system by incorporating a boot. In addition, the inventive microporous polyolefinic plate wrap may be wrapped, folded and/or sealed along the bottom, edge, side, and/or sides to form a pocket, sleeve, and/or envelope. Although Glassmat, Plate wrap and Separator are shown to the left of the Positive Electrode, it is understood that there would be, in various embodiments, Glassmat, Plate wrap and Separator on both sides of the Positive Electrode.

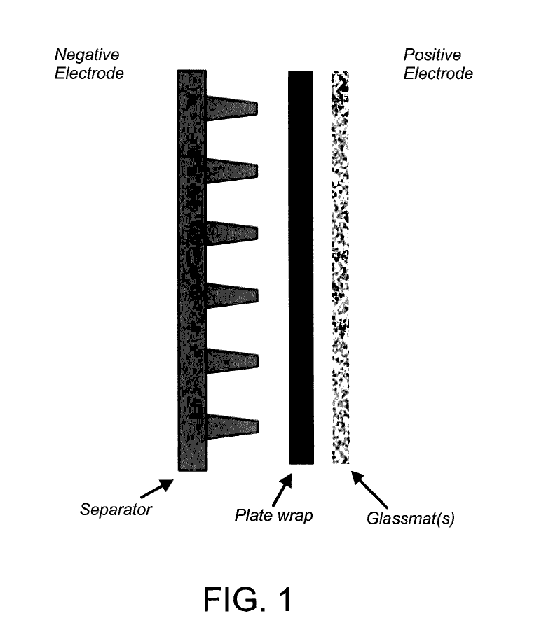

FIG. 2 depicts a four-point system in which the traditional separator has been replaced with an inventive spacer made of a different material. The depicted 4-point system may easily be converted to a 5-point system by incorporating a boot. In addition, the inventive microporous polyolefinic plate wrap may be sealed along the bottom or sides to form a pocket or sleeve.

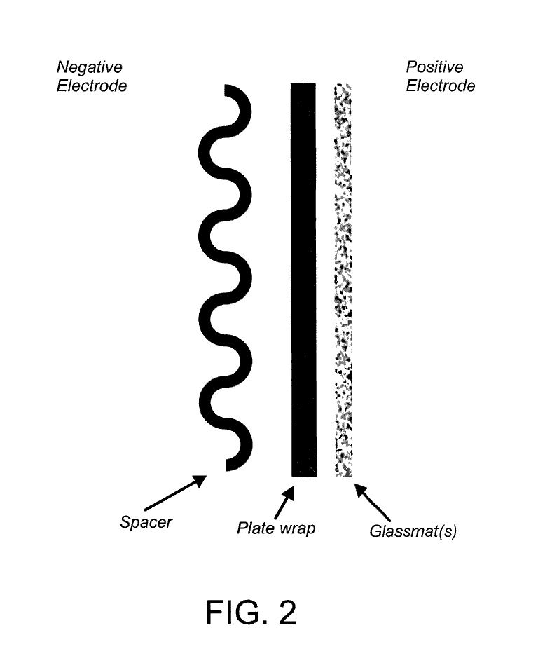

FIG. 3 depicts a 4-point system in which the inventive polyolefinic plate wrap is laminated directly onto the absorbent glassmat or combination glassmat with glass yarn strains or strands known as a slyver mat. The depicted 4-point system may easily be converted to a 5-point system by incorporating a boot. In addition, the inventive microporous polyolefinic plate wrap may be sealed along the bottom or sides to form a pocket or sleeve.

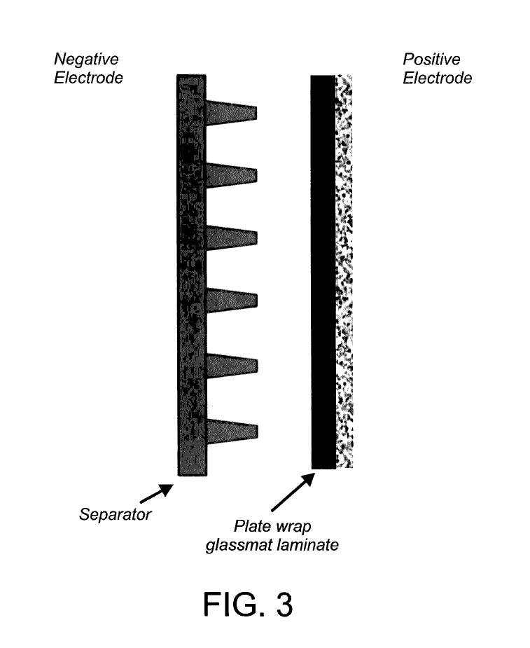

FIG. 4 depicts a 3-point system in which an inventive polyolefinic plate wrap having ribs has replaced both the PVC plate wrap and traditional separator. The depicted 3-point system may easily be converted to a 4-point system by incorporating a boot. In addition, the inventive microporous polyolefinic plate wrap may be sealed along the bottom or sides to form a pocket or sleeve.

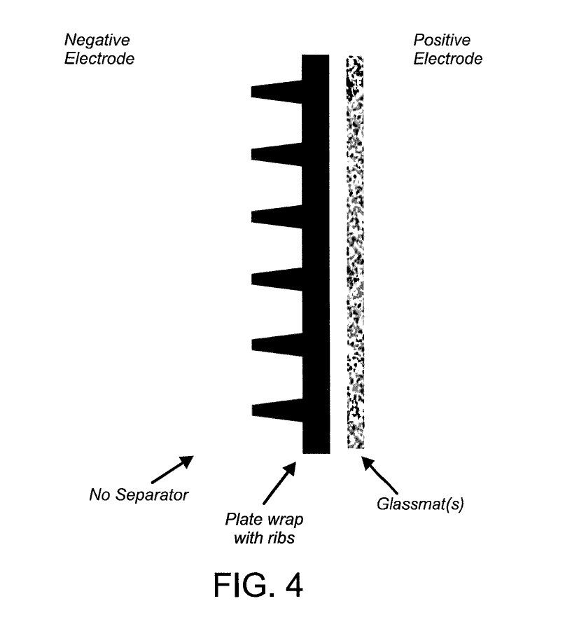

FIG. 5 depicts the typical components found in a lead acid battery with a perforated PVC plate wrap.

FIG. 6 depicts the typical components including a slyver mat, glass mat and plate wrap wrapped around a positive electrode, a separator sleeve, a boot, and a negative plate.

### DETAILED DESCRIPTION

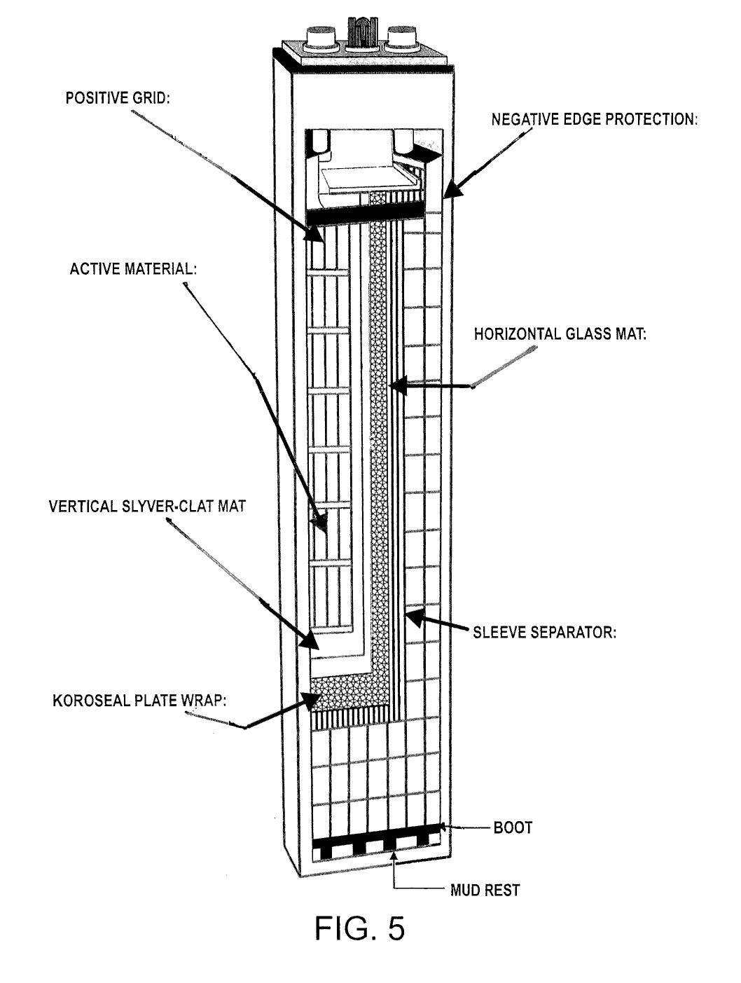

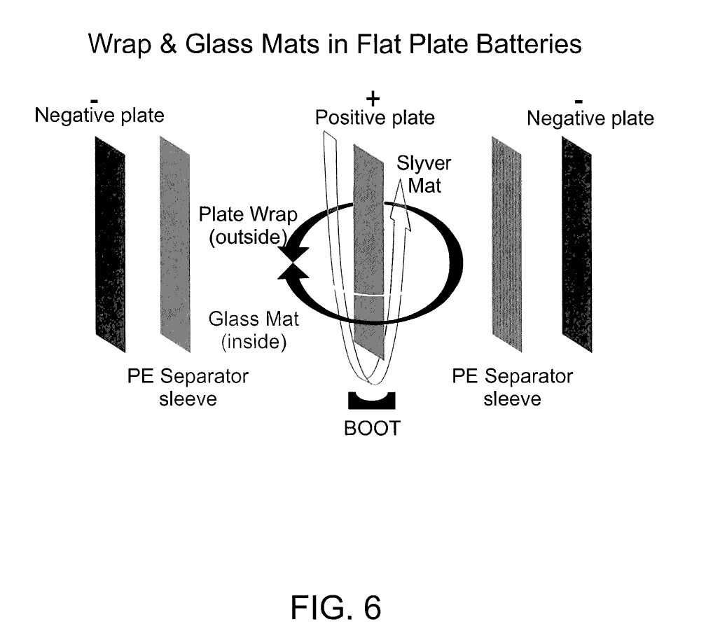

Disclosed herein are novel or improved plate wraps made of porous, preferably microporous, polyolefin, preferably polyethylene. The preferred plate wraps do not contain a PVC polymer. The polyolefinic plate wraps may serve as a drop-in replacement for currently existing PVC plate wraps used in the manufacture of 5-point battery systems (see FIGS. 5 and 6). Because the porous polyolefinic plate wrap is permeable to the electrolyte, it can also serve to augment the function of the traditional battery separator. In some instances, the polyolefinic plate wrap can replace the separator altogether, thereby permitting either the introduction of additional active material into the battery and/or reduction in the size of the battery. Unlike conventional PVC plate wraps, the inventive polyolefinic plate wraps may not require a separate or additional sleeve of separator to retain the active material. Also, in at least particular embodiments, the inventive polyolefinic plate wraps may be sealed along the bottom to form a microporous pocket to retain active material, to enclose the plate, or the like. A wrapped or sealed plate or electrode can then be affixed to a traditional PVC boot, to a novel or improved non-PVC boot, or to the mud rest or battery case if desired (for example, for certain high vibration environs). Also, the conventional PVC wrap and PVC boot may be eliminated altogether to provide a PVC-free battery, industrial battery, traction battery, fork lift battery, or the like. Removing the PVC boot may permit the introduction of additional active material into the battery and/or reduction in the size of the battery. Also, in at least certain embodiments, the inventive polyolefinic plate wraps may be sealed and/or folded along the bottom or sides to form a microporous pocket, envelope, sleeve, or the like.

The porous polyolefinic wrap may be a microporous polyethylene sheet or membrane which preferably does not contain any polyvinyl chloride (PVC). The polyolefin may be a polyethylene, and may further include a filler or gel, such as silica or silica gel. In certain embodiments, the polyolefin to silica ratio may be higher than that found in conventional polyethylene separators, for instance, the polyolefin plate wrap may have a weight ratio of polyolefin to silica that is from about 1:1.8 to 1:3.5, in some embodiments, 1:2 to 1:2.5.

The preferred polyolefinic wrap is microporous, and characterized by a pore size that is smaller than the particle size of the lead. As such, the polyolefinic plate wrap retains lead paste much more effectively than the macro-opening perforated polyvinyl chloride wraps.

The polyolefinic wrap may be of any height (wrapped horizontally around the plate, typically comes on a roll and cut to length). For instance, KOROSEAL® is available in different widths to accommodate different plate heights, and so a polyolefinic wrap intended as a drop in replacement will have the same variety in widths. In accordance with certain embodiments, the plate wrap may be provided in widths from about 2 inches to about 20 inches wide, with possibly preferred widths from about 5 inches to about 15 inches depending on the plate height, whether a boot is used, if the wrap is to be sealed along the bottom, to be adhered to the case, to be adhered to the mud rest, or the like. The polyolefinic wrap may be thinner than polyolefinic materials used for battery separators, for instance, the plate wrap may be from about 0.2 mm to about 0.55 mm thick. The inward directed face of the wrap is typically smooth, in order to maximize contact with the absorbent glass mat, but may be ribbed, corrugated, embossed, shaped, or the like, vertical ribs may be preferred. The outward directed face may be smooth, corrugated, embossed, ribbed, shaped, or the like. Vertical ribs may be useful to facilitate elimination of gas bubbles from the electrolyte. Horizontal ribs may be useful to prevent or reduce acid stratification. The height of the ribs are preferably low or short towards the positive plate and high or long towards the negative plate. Such ribs may be referred to in some embodiments as mini-ribs. They may be 3-10 mils high, in some cases, 3-7 mils high, in some cases, 3-6 mils high, and so forth. Such ribs, such as mini-ribs, may be spaced 1-10 mm apart, in some embodiments, 2-8 mm apart, in other embodiments, 3-5 mm apart. Also, such mini-ribs may run longitudinal or transverse.

The polyolefinic plate wrap may further contain a heat-meltable polymer, or heat sealing additive, either throughout the entire body of the wrap, or only along one or more edges of the wrap. Exemplary heat-meltable polymers include low MW PE. One heat sealing additive is oil. When present through the entire body of the wrap, the polymer serves to facilitate adhesive of the plate wrap to the glassmat or other component of the electrical cell. When present along one or more edges of the wrap, the polymer facilitates joining the edges of the wrap together in order to form a sleeve or pocket. The polyolefinic plate wrap may be tacked, sealed or bonded using, for example, heat, ultrasound, solvent, adhesive, hot melt adhesive, or the like.

The polyolefinic plate wrap may further contain one or more additives to further improve the performance of the battery. For instance, the polyolefinic wrap may contain one or more antioxidants, additives, agents, colorants, and/or the like such as may be used in battery separators. Exemplary additives include, but are not limited to, coatings, latex rubber, lead migration inhibitors and dehydrol. Such additives, for example, a latex and/or rubber additive, may provide desired antimony suppression to the polyolefinic plate wrap of the present invention, helping the battery avoid antimony poisoning. In some embodiments, the microporous polyolefin plate wrap may include a coating, agent, additive, or treatment on one or both sides thereof. Such a coating may include an oil, alcohol, surfactant, and/or other material. In some embodiments, the coating may include one or more materials described, for example, in U.S. Patent Publication No. 2012/0094183, which is incorporated by reference herein. Such a coating may, for example, reduce the overcharge voltage of the battery system, thereby extending battery life with less grid corrosion and preventing dry out and/or water loss. Such a coating may be added to the plate wrap in an amount of from 3 gsm to 15 gsm, in some embodiments, 5-10 gsm. In various embodiments, the coated separator has desirable oxidation resistance performance

In some embodiments, the polyethylene plate wraps may be characterized by a backweb that is from about 0.150 mm to about 0.450 mm thick, preferably from about 0.150 mm to about 0.350 mm thick, in some embodiments, preferably from about 0.210 mm to about 0.290 mm thick, and an overall thickness that is from about 0.175 mm to about 0.55 mm, in some cases, 0.20 mm to about 0.55 mm, preferably from about 0.28 mm to about 0.48 mm. The plate wrap may be characterized further by one or more of the features below, falling between the minimum (LOW) and maximum (HIGH) or Preferred thresholds.

| Characteristic | Unit | LOW | HIGH | Preferred |
|---|---|---|---|---|
| Puncture | (N) | 9 | 20 | 9-20 |
| Total Extractables | (%) | 12 | 28 | 12-28 |
| Ash | (%) | 59 | 73 | 59-73 |
| Si:PE Ratio | | 1.8 | 3.0 | 2-2.5 |
| Porosity | (%) | 30 | 70 | 40-60 |
| Acid Wetout | (sec) | 5 | 600 | 5-60 |

Also disclosed herein are novel or improved electrodes or plates covered by the inventive polyolefinic plate wrap. It is preferred that at least the positive electrode has the inventive polyolefinic plate wrap. It is understood that the wrapped electrode may be the positive and/or the negative electrode or plate. The novel or improved electrode or plate may further contain an absorbent glassmat between the electrode and plate wrap. In certain embodiments, there may also be a slyver mat between the electrode and glassmat. The polyolefinic wrap may be wrapped around or may overlay the absorbent glassmat, or may be laminated directly onto the glassmat or a combination slyver and glass mat. The polyolefinic wrap may be sealed along the vertical edge to form a sleeve, or the polyolefinic wrap may be sealed along the vertical and bottom horizontal edge to form a pocket. As used herein, the sleeve and pocket embodiments are collectively referred to as a “wrapped electrode.”

Many different types of electrochemical cells may be prepared using the wrapped electrode. For instance, a traditional 5-point system contains the wrapped electrode (the electrode, the glassmat, with or without an additional slyver mat, and the plate wrap, such as traditional PVC plate wrap), a conventional battery separator, and an electrode of opposite polarity to that of the wrapped electrode. In such a traditional 5-point system, the wrapped electrode may be present either as a sleeve or a pocket, which is affixed to a boot. In other embodiments, the wrapped electrode, preferably in the pocket form, may be in a 4-point system which does not contain a PVC boot.

In other embodiments, an electrochemical cell may contain the wrapped electrode and an electrode of opposite polarity to that of the wrapped electrode. The wrapped electrode may be present either as a sleeve or pocket, which may or may not be affixed to a boot. This cell is further characterized by the absence of a conventional battery separator (such as a polyethylene separator), making it, in some embodiments, an improved or novel 3-point system. The cell may be characterized either by the absence of an additional material between the wrapped electrode and other electrode, or by the presence of spacer made of a material other than a polyethylene separator between the electrodes. Suitable spacer materials include porous polyolefins, synthetic fibers, glass fibers, nonwovens, and/or the like. By eliminating the separator or the spacer, or by replacing one or both of them with a small or thin material, the overall size of the battery may be reduced, and/or additional electrolyte, active material, and/or cells may be added to the battery.

### EXAMPLES

### Example 1

### Polyethylene Flatsheet Plate Wrap

A microporous polyethylene flatsheet was prepared having an average pore size of 0.15 μm (0.006 mils) and a maximum pore diameter of 1 μm.

### Example 2

### Battery A

An industrial battery was prepared having plate wrap made from a polyethylene flatsheet according to Example 1 above and having a backweb thickness of about 10 mils, and low profile, narrowly spaced ribs extending about 3-10 mils from the flatsheet (with the overall thickness quoted below in the table). The flatsheet contained silica in a 2.2:1 to 2.3:1 silica:polymer ratio, and further contained a functionalized coating or additive. The coating was applied at a rate of approximately 7 g/m². In comparison to a similar battery having the KOROSEAL® separator, the batteries having the polyethylenic plate wrap exhibited a 5% increase in battery capacity. Separator data from Sample A are reproduced below:

| Characteristic | Unit | Sample A |
|---|---|---|
| Basis Weight | (gsm) | 182 |
| Backweb | (mm) | 0.256 |
| Overall | (mm) | 0.381 |
| Puncture | (N) | 11.5 |
| Elongation—CMD | (%) | 504 |
| PEROX—40 hrs | (%) | 400 |
| Total Extractables | (%) | 15.1 |
| Ash | (%) | 63.3 |
| Si:PE Ratio | | 2.2 |
| Porosity | (%) | 51 |
| Acid Wetout | (sec) | 32 |
| Coating | (gsm) | 7 |

In accordance with at least selected embodiments, aspects or objects, the present disclosure or invention may address the needs or issues related to conventional plate wraps and/or boots, and may provide improved plate wraps for lead acid batteries, improved wrapped plates, improved systems, improved batteries or cells, non-PVC plate wraps, non-PVC wrapped plates, non-PVC batteries, and/or methods of production and/or use thereof. In accordance with at least certain embodiments, aspects or objects, novel or improved polyolefinic plate wraps, wrapped plates, and lead acid batteries, such as industrial batteries, are provided. The novel or improved polyolefinic plate wraps of the present invention may provide batteries or cells with improved performance, reduced lead content, or both.

Disclosed herein are novel or improved plate wraps made of porous, preferably microporous, polyolefin, preferably polyethylene. The preferred plate wraps do not contain a PVC polymer. The polyolefinic plate wraps may serve as a drop-in replacement for currently existing PVC plate wraps used in the manufacture of conventional 5-point battery systems (see FIG. 5). Because the polyolefinic plate wrap is permeable to the electrolyte, it can also serve to augment the function of the traditional battery separator. In some instances, the polyolefinic plate wrap can replace the separator altogether, thereby permitting either the introduction of additional active material into the battery and/or reduction in the size of the battery. Unlike conventional PVC plate wraps, the inventive microporous polyolefinic plate wraps may not require an additional or separate sleeve of separator to retain the active material. Also, in at least particular embodiments, the inventive polyolefinic plate wraps may be sealed along the bottom to form a microporous pocket or envelope to retain active material, to enclose the plate, and/or the like. A wrapped or sealed plate or electrode can then be affixed to a traditional PVC boot, to a novel or improved non-PVC boot, to a mud rest, or to the battery case if desired (for example, for certain high vibration environs). Also, the conventional PVC wrap and PVC boot may be eliminated altogether to provide a PVC-free battery. Removing the boot may permit the introduction of additional active material into the battery and/or reduction in the size of the battery.

Disclosed herein are novel or improved porous polyolefinic plate wrap materials for batteries. The use of such polyolefinic wraps may simplify the construction of batteries, produce more efficient batteries, and/or the like.

Disclosed or shown herein are novel or improved plate wraps for lead acid batteries, improved wrapped plates, improved batteries or cells, non-PVC plate wraps, non-PVC wrapped plates, non-PVC batteries, and/or methods of production and/or use thereof, novel or improved polyolefinic plate wraps, wrapped plates, and lead acid batteries, such as industrial batteries, batteries or cells with improved performance, reduced lead content, or both, novel or improved plate wraps made of porous, preferably microporous, polyolefin, preferably polyethylene, preferred plate wraps that do not contain a PVC polymer, polyolefinic plate wraps that serve as a drop-in replacement for currently existing PVC plate wraps used in the manufacture of 5-point battery systems, polyolefinic plate wraps permeable to the electrolyte, that can also serve to augment the function of traditional battery separators, polyolefinic plate wraps that can replace the separator altogether, that permit either the introduction of additional active material into the battery and/or reduction in the size of the battery, polyolefinic plate wraps that may not require a separate or additional sleeve of separator to retain the active material, polyolefinic plate wraps that may be sealed along the bottom to form a microporous pocket to retain active material, to enclose the plate, and/or the like, wrapped or sealed plate or electrode that can then be affixed to a traditional PVC boot, to a novel or improved non-PVC boot, or to the battery case if desired (for example, for certain high vibration environs), a system that eliminates conventional PVC wraps and/or PVC boots, a PVC-free battery or cell, methods, systems, wraps, and/or the like to reduce lead content, to improve battery performance, to permit the introduction of additional active material into the battery, and/or to reduce the size of the battery, and/or the like.

Disclosed herein are novel or improved porous polyolefinic plate wrap materials for batteries, improved wrapped plates, improved systems, improved batteries or cells, non-PVC plate wraps, non-PVC wrapped plates, non-PVC batteries, and/or methods of production and/or use thereof. The use of such polyolefinic wraps may simplify the construction of batteries, produce more efficient or robust batteries, and/or the like.

The present invention may be embodied in other forms without departing from the spirit and the essential attributes thereof, and, accordingly, reference should be made to the appended claims, rather than to the foregoing specification, as indicating the scope of the invention. Additionally, the invention illustratively disclosed herein suitably may be practiced in the absence of any element which is not specifically disclosed herein.

What is claimed is:

1. A lead acid battery plate wrap comprising a porous polyolefin membrane or sheet.

2. The plate wrap of claim 1, wherein substantially no polyvinylchloride is present.

3. The plate wrap of claim 1, wherein the polyolefin is polyethylene.

4. The plate wrap of claim 1, comprising a silica filler.

5. The plate wrap of claim 4, wherein the weight ratio of polyolefin to silica is from about 1:1.8 to 1:3.5.

6. The plate wrap of claim 1, having a backweb thickness from about 0.15 to 0.45 mm.

7. The plate wrap of claim 1, wherein an electrode facing side of the wrap is smooth, ribbed, embossed, shaped, or corrugated, and an outward facing side of the wrap is smooth, ribbed, embossed, shaped, or corrugated.

8. The plate wrap of claim 1, comprising transverse ribs on at least one side.

9. The plate wrap of claims 1, comprising a heat-meltable polymer along at least vertical edges of the wrap, wherein said polymer comprises a low molecular weight polymer.

10. The plate wrap of claim 1, comprising a coating, an oil, a surfactant, an alcohol, a heat sealing additive, an antioxidant, a water-loss inhibitor, or other additive or agent.

11. An electrochemical element, wrapped plate, or cell comprising
a) a first electrode;
b) the plate wrap of claim 1, wherein the plate wrap surrounds the first electrode.

12. The element of claim 11, comprising at least one slyver mat or glass mat between the first electrode and the plate wrap.

13. The element of claim 12, comprising a slyver mat between the glass mat and the first electrode.

14. The element of claim 11, wherein the plate wrap is sealed along a vertical edge.

15. The element of claim 11, wherein the plate wrap is sealed along a bottom horizontal edge.

16. The element of claim 11, wherein the plate wrap is affixed to a boot, mud rest or casing at a bottom horizontal edge.

17. The element of claim 11, wherein the element is part of a 5 point system, 4 point system, or 3 point system.

18. A lead acid battery, comprising:
a) the electrochemical element of claim 11;
b) a second electrode of opposite polarity to the first electrode; and
c) electrolyte.

19. The battery of claim 18, comprising a separator between the electrochemical element and the second electrode, wherein the separator does not surround the first electrode.

20. The battery of claim 19, wherein the separator comprises microporous polyethylene.

21. The battery of claim 18, which does not contain a separator between the electrochemical element and the second electrode.

22. The battery of claim 21, comprising a spacer between the electrochemical element and the second electrode.

23. The battery of claim 22, wherein the spacer comprises a shaped, ribbed, embossed, or corrugated porous member or material.
